(19) United States
(12) Patent Application Publication
(10) Pub. No.: US 2026/0023183 A1
(43) Pub. Date: Jan. 22, 2026

(54) LIDAR DATA PROCESSING METHOD AND APPARATUS

(71) Applicant: SUTENG INNOVATION TECHNOLOGY CO, LTD, Shenzhen, Guangdong (CN)

(72) Inventor: Yan Zhao, Shenzhen (CN)

(73) Assignee: SUTENG INNOVATION TECHNOLOGY CO., LTD., Shenzhen, Guangdong Province (CN)

(21) Appl. No.: 18/664,282

(22) Filed: May 14, 2024

(51) Int. Cl. G01S 17/89; G01S 7/481; G01S 7/484; G01S 7/4865

(52) U.S. Cl. CPC G01S 17/89; G01S 7/4815; G01S 7/484; G01S 7/4865

(57) ABSTRACT

Embodiments of this application provides a LiDAR data processing method and apparatus, the method comprises: emitting laser beams multiple times; sampling echoes of a laser beam emitted for one time by at least two receiving blocks to obtain sampling data of the at least two receiving blocks for the laser beam emitted for one time respectively, a first receiving block in the at least two receiving blocks is used to sample a laser beam emitted for an N^{th} time and a laser beam emitted for an (N+1)^{th} time; obtaining a point cloud data of the laser beam emitted for one time; and generating a frame of point cloud data based on the point cloud data of the laser beam emitted for one time corresponding to at least one of the receiving blocks, which can reduce the cost of LiDAR.

### CROSS-REFERENCE TO RELATED APPLICATION

The present application claims the benefit of priority to Chinese Patent Application No. 202310670659.7, filed on Jun. 7, 2023, which is hereby incorporated by reference in its entirety.

### TECHNICAL FIELD

This application relates to the field of laser detection, and particularly to a LiDAR data processing method and apparatus.

### BACKGROUND

LiDAR is an active remote sensing device that uses optoelectronic technology for detection. It combines optoelectronic detection technology with laser technology, making it an advanced detection method that uses laser as the detection light source. LiDAR includes an emitting module, a scanning module, a receiving module, a data processing module, etc. The emitting module emits detection signals towards targets, the scanning module changes the emission direction of the detection signals, the receiving module samples the echo signals of the detection signals to obtain sampling data, and the data processing module processes this sampling data to obtain point cloud data of the detected targets, which includes information such as distance, reflectivity, velocity, size, etc.

The sampling data obtained by multiple detections by the receiving module of the LiDAR is processed by the data processing module to obtain point cloud data of multiple detections. However, the echoes of the laser beam reflected by objects at different distances to the LiDAR do not converge at the same spot on the receiving block when collected by the LiDAR, the farther objects' echoes have larger offsets on the receiving block compared to the echoes from closer objects. Therefore, the receiving module needs a larger area to ensure the reception of the spot, leading to higher costs and difficulties in miniaturization of the LiDAR.

### SUMMARY

This application provides a method and apparatus for data processing of LiDAR to reduce the cost of LiDAR systems.

In a first aspect, the application provides a LiDAR data processing method, comprising:
emitting laser beams for multiple times; sampling echoes of a laser beam emitted for one time by at least two receiving blocks, to obtain sampling data of the at least two receiving blocks for the laser beam emitted for one time respectively, wherein a first receiving block in the at least two receiving blocks is used to sample a laser beam emitted for an Nth time and a laser beam emitted for an (N+1)^{th} time, and a second receiving block in the at least two receiving blocks is used to sample a laser beam emitted for the Nth time but is not used to sample a laser beam emitted for the (N+1)^{th} time, where N is an integer greater than or equal to 1;
obtaining a point cloud data of the laser beam emitted for one time corresponding to the at least two receiving blocks respectively, based on the sampling data of the at least two receiving blocks for the laser beam emitted for one time respectively; and
generating a frame of point cloud data based on the point cloud data of the laser beam emitted for one time corresponding to at least one of the receiving blocks.

In an embodiment, the generating a frame of point cloud data based on the point cloud data of the laser beam emitted for one time corresponding to at least one of the receiving blocks comprises:
for the first receiving block, fusing point cloud data of the first receiving block corresponding to respective laser beams emitted in a preset time interval into compressed point cloud data corresponding to the preset time interval; and generating a frame of point cloud data based on the compressed point cloud data of the first receiving block corresponding to the preset time interval.

In an embodiment, the step of emitting laser beams for multiple times comprises:
emitting laser beams along a row in sequence at different azimuth angles, and a difference between a maximum emission pitch angle and a minimum emission pitch angle of the laser beams emitted along the row is less than a preset angle, and the preset time interval is at least a part of an emission time interval corresponding to the laser beams emitted along the row.

In an embodiment, the fusing point cloud data of the first receiving block corresponding to respective laser beams emitted in a preset time interval into compressed point cloud data corresponding to the preset time interval comprises: storing point cloud data of the first receiving block corresponding to respective laser beams in the preset time interval into a buffer in sequence, wherein before the i^{th} time of storing the point cloud data into the buffer, point cloud data obtained at the i^{th} time is fused with point cloud data stored in the buffer at the (i−1)^{th} time into point cloud data, stored in the buffer at the i^{th} time, i is an integer greater than or equal to 1, and wherein the point cloud data obtained at the i^{th} time is point cloud data of the first receiving block corresponding to an i^{th} laser beam in the preset time interval.

In an embodiment, the fusing point cloud data of the first receiving block corresponding to respective laser beams emitted in a preset time interval into compressed point cloud data corresponding to the preset time interval further comprises: releasing point cloud data of the first receiving block stored in the buffer at the (i−1)^{th} time before the i^{th} time of storing the point cloud data into the buffer.

In an embodiment, the buffer comprises at least two partitions, a number of the at least two partitions is the same as a number of the at least two receiving blocks, and each of the at least two partitions is used to store point cloud data of a corresponding one of the at least two receiving blocks, and point cloud data of the at least two receiving blocks is stored in the buffer in a serial manner.

In an embodiment, the first receiving block comprises a plurality of receiving units, and the sampling data of the first receiving block for the laser beam emitted for one time comprises sampling data of a plurality of the receiving units in the first receiving block for the laser beam emitted for one time respectively, and the plurality of receiving units comprise a first receiving unit, and the obtaining the point cloud data of the laser beam emitted for one time corresponding to the at least two receiving blocks respectively based on the sampling data of the at least two receiving blocks for the laser beam emitted for one time respectively comprises: obtaining a group of point cloud data of a first receiving unit corresponding to the laser beam emitted for one time based on the sampling data of the first receiving unit for the laser beam emitted for one time, and the fusing point cloud data of the first receiving block corresponding to respective laser beams emitted in a preset time interval into compressed point cloud data corresponding to the preset time interval comprises: compressing groups of point cloud data corresponding to the first receiving unit for respective laser beams emitted in the preset time interval into a compressed group of point cloud data.

In an embodiment, the compressing groups of point cloud data corresponding to the first receiving unit for respective laser beams emitted in the preset time interval into a compressed group of point cloud data comprises: storing point cloud data of the first receiving unit corresponding to respective laser beams in the preset time interval into the buffer in sequence, and wherein before the i^{th} time of storing the point cloud data into the buffer, point cloud data obtained at the i^{th} time is fused with point cloud data stored in the buffer at the (i−1)^{th} time into a group of fused point cloud data, and the group of fused point cloud data is used as point cloud data stored in the buffer at the i^{th} time or as part of the compressed point cloud data, and i is an integer greater than 1, and wherein the point cloud data obtained at the i^{th} time is point cloud data of the first receiving unit corresponding to an i^{th} laser beam in the preset time interval.

In an embodiment, the point cloud data obtained at the i^{th} time is fused with point cloud data stored in the buffer at the (i−1)^{th} time into a group of fused point cloud data comprises:
obtaining a difference between the Point cloud data obtained at the i^{th} time and the point cloud data stored in the buffer at the (i−1)^{th} time, and when the difference is less than a preset difference, obtaining a weighted sum of the point cloud data obtained at the i^{th} time and the point cloud data stored in the buffer at the (i−1)^{th} time as the group of fused point cloud data.

In an embodiment, the point cloud data comprises a light spot area, and the light spot area is determined based on optical energy sampled by the first receiving unit for the laser beam emitted for one time, and the point cloud data obtained at the i^{th} time is fused with point cloud data stored in the buffer at the (i−1)^{th} time into a group of fused point cloud data further comprises: when the difference is not less than the preset difference, determining the group of fused point cloud data based on the light spot area of the point cloud data obtained at the i^{th} time and the light spot area of the point cloud data stored in the buffer at the (i−1)^{th} time.

In an embodiment, the determining the group of fused point cloud data based on a light spot area of the point cloud data obtained at the i^{th} time and a light spot area of the point cloud data stored in the buffer at the (i−1)^{th} time comprises: when the light spot area of the point cloud data obtained at the i^{th} time is not less than the light spot area of the point cloud data stored in the buffer at the (i−1)^{th} time, performing at least one of the following:
When a value of the light spot area or a distance of the group of point cloud data stored in the buffer at the (i−1)^{th} time is 0, determining the point cloud data obtained at the i^{th} time as the group of fused point cloud data;
when the light spot area of the group of point cloud data obtained at the i^{th} time is greater than a saturation area, the light spot area of the group of point cloud data stored in the buffer at the (i−1)^{th} time is greater than a preset area, a difference between the light spot area of the group of point cloud data obtained at the i^{th} time and the light spot area of the group of point cloud data stored in the buffer at the (i−1)^{th} time is less than a preset area comparison threshold, and a value of the distance of the group of point cloud data stored in the buffer at the (i−1)th time is not 0, determining the group of point cloud data stored in the buffer at the (i−1)th time as the group of fused point cloud data; and
when the light spot area of the group of point cloud data obtained at the i^{th} time is not greater than the saturation area, the light spot area of the group of point cloud data stored in the buffer at the (i−1)^{th} time is not greater than the preset area, the difference between the light spot area of the group of point cloud data obtained at the i^{th} time and the light spot area of the group of point cloud data stored in the buffer at the (i−1)^{th} time is not less than a preset area comparison threshold, the difference between the distance of the group of point cloud data obtained at the i^{th} time and the distance of the group of point cloud data stored in the buffer at the (i−1)^{th} time is less than a preset distance comparison threshold, or the value of the distance of the group of point cloud data stored in the buffer at the (i−1)^{th} time is 0 and the light spot area is not 0, determining the group of point cloud data obtained at the i^{th} time as the group of fused point cloud data.

In an embodiment, the step of determining the group of fused point cloud data based on a light spot area of the point cloud data obtained at the i^{th} time and a light spot area of the point cloud data stored in the buffer at the (i−1)^{th} time comprises: when the light spot area of the point cloud data obtained at the i^{th} time is less than the light spot area of the point cloud data stored in the buffer at the (i−1)^{th} time, performing at least one of the following:
when the light spot area of the group of point cloud data stored in the buffer at the (i−1)^{th} time is greater than a saturation area and the value of the distance of the group of point cloud data obtained at the i^{th} time is not 0, determining the group of point cloud data obtained at the i^{th} time as the group of fused point cloud data; and
when the light spot area of the group of point cloud data stored in the buffer at the (i−1)^{th} time is not greater than the saturation area or the value of the distance of the group of point cloud data obtained at the i^{th} time is 0, determining the group of point cloud data stored in the buffer at the (i−1)^{th} time as the group of fused point cloud data.

In an embodiment, the group of point cloud data obtained at the i^{th} time comprises a light spot area, and the light spot area is determined based on optical energy sampled by the first receiving unit for the i^{th} laser beam in the preset time interval, and prior to obtaining the difference between the group of point cloud data obtained at the i^{th} time and the group of point cloud data stored in the buffer at the (i−1)^{th} time, it further comprises: determining that the light spot area of the group of point cloud data obtained at the i^{th} time is not less than the preset area.

In an embodiment, the storing the group of point cloud data of the first receiving unit corresponding to respective laser beams in the preset time interval into the buffer in sequence further comprises: when determining that the light spot area of the group of point cloud data obtained at the i^{th} time is less than the preset area, determining whether the light spot area of the group of point cloud data stored in the buffer at the (i−1)^{th} time is less than the preset area, and
when the light spot area of the group of point cloud data stored in the buffer at the (i−1)^{th} time is less than the preset area, storing the group of point cloud data obtained at the i^{th} time into the buffer at the i^{th} time, and/or
when the light spot area of the group of point cloud data stored in the buffer at the (i−1)^{th} time is not less than the preset area, storing the group of point cloud data stored in the buffer at the (i−1)^{th} time into the buffer at the i^{th} time.

In a second aspect, provides a sampling data processing apparatus, the apparatus includes an emitting module, a sampling module, an obtaining module and a generating module.

The emitting module is configured to emit laser beams for multiple times.

The sampling module comprises at least two receiving blocks, wherein the at least two receiving blocks are configured to sample echoes of a laser beam emitted for one time, to obtain sampling data of the at least two receiving blocks for the laser beam emitted for one time respectively, wherein a first receiving block in the at least two receiving blocks is used to sample a laser beam emitted for an Nth time and a laser beam emitted for an (N+1)th time, and a second receiving block in the at least two receiving blocks is used to sample a laser beam emitted for the Nth time but is not used to sample a laser beam emitted for the (N+1)th time, and N is an integer greater than or equal to 1.

The obtaining module is configured to obtain a point cloud data of the laser beam emitted for one time corresponding to the at least two receiving blocks respectively based on the sampling data of the at least two receiving blocks for the laser beam emitted for one time respectively; and the generating module is configured to generate a frame of point cloud data based on the point cloud data of the laser beam emitted for one time corresponding to at least one of the receiving blocks.

The embodiments of the apparatus module can be implemented by referring to the embodiments of the method.

In a third aspect, provides a LiDAR, the LiDAR includes a processor; and a memory, wherein executable code is stored on the memory, and when the executable code is executed by the processor, the processor performs any one of the method embodiments.

In the embodiments of the present application, the echoes of a laser beam emitted for one time are sampled by at least two receiving blocks, with one receiving block sampling echoes from adjacent emissions at least twice. This configuration ensures that the echoes of the laser beam emitted for that time can be collected by the receiving blocks in the sampling module while keeping the number of receiving blocks in the sampling module relatively low. This setup helps reduce the cost of LiDAR systems and contributes to miniaturization.

### BRIEF DESCRIPTION OF DRAWINGS

FIG. 1 is a schematic diagram of an embodiment of a LiDAR data processing method;

FIG. 2 is a schematic diagram of an embodiment of an emitting module and a sampling module of the LiDAR;

FIG. 3 is a schematic diagram of the working timing relationship of the emitting module and the sampling module as shown in FIG. 2;

FIG. 4 is a schematic diagram of the compression process of point cloud data corresponding to the first three emissions in a row of receiving blocks 22 as shown in FIG. 3;

FIG. 5 is a schematic diagram of the compression process of point cloud data corresponding to the 4^{th}-8^{th} emissions in a row of receiving blocks 22 as shown in FIG. 3;

FIG. 6 is a schematic diagram of the compression process of point cloud data corresponding to the 9^{th}-11^{th} emissions in a row of receiving blocks 22 as shown in FIG. 3;

FIG. 7 is a schematic diagram of the compression process of point cloud data corresponding to the 12^{th} emission in a row of receiving blocks 22 as shown in FIG. 3;

FIG. 8 is a schematic diagram of an embodiment of a sampling data processing apparatus; and

FIG. 9 is a schematic diagram of an embodiment of a LiDAR in an embodiment.

### DETAILED DESCRIPTION

The following detailed description of the embodiments of the present application will be described with reference to the accompanying drawings. The terms used are solely for describing embodiments. The singular forms “a,” “an,” and “the” used in embodiments and the appended claims are intended to encompass plural forms unless the context clearly indicates otherwise. The term “and/or” used herein refers to any or all possible combinations of one or more of the associated listed items.

Although terms such as “first,” “second,” “third,” etc., may be used to describe various information, these terms are used to distinguish the same type of information from each other. For example, the first information can also be referred to as the second information, and similarly, the second information can also be referred to as the first information. Therefore, features designated as “first,” “second” may explicitly or implicitly include one or more of that feature. In the description, the meaning of “multiple” is two or more, unless otherwise specifically defined.

LiDAR is a radar system that detects the position, velocity, and other characteristics of targets by emitting laser beams. The working principle of the LiDAR is to use a laser emitter to emit a plurality of laser beams in sequence. If a laser beam encounters an object, it is reflected, and the reflected echo is received by a receiver. LiDAR can be a mechanical LiDAR, a semi-solid LiDAR, or a pure solid LiDAR, among others. LiDAR calculates the time difference between receiving the reflected echo and emitting the laser beam, which represents the flight time of the laser beam. Based on this flight time, LiDAR can calculate parameters such as the distance and azimuth of the object reflecting the echo, or it can calculate the reflectivity based on the energy of the echo and the energy of the emitted laser beam, thereby detecting the surrounding environment.

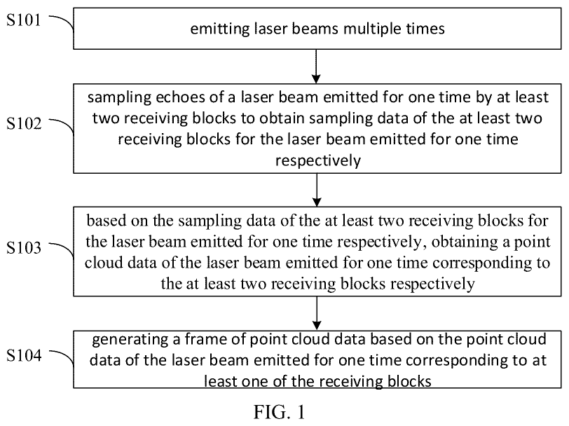

As shown in FIG. 1, FIG. 1 is a schematic diagram of an embodiment of the LiDAR data processing method. The LiDAR data processing method 100 comprises:

Step S101, emitting laser beams multiple times.

In an embodiment, an emitting module is installed inside the LiDAR, through which laser beams are emitted sequentially. Each emission of a laser beam can involve emitting one beam or simultaneously emitting at least two laser beams, where the emission directions of these at least two laser beams can be the same or different. Additionally, the emission directions of different laser beams can be the same or different. In an embodiment, the LiDAR includes a scanning module to alter the emission direction of the laser beams, to scan sequentially along different directions.

In an embodiment, the LiDAR emits laser beams sequentially along a row at different azimuth angles, where the maximum emission pitch angle and the minimum emission pitch angle of the laser beams emitted along the row have a difference less than a preset angle. In some examples, after emitting laser beams sequentially along a row at different azimuth angles, the LiDAR adjusts the emission pitch angle and then continues to emit laser beams sequentially along another row at different azimuth angles, repeating this process to scan along multiple rows. In the resulting frame of point cloud data from such scanning, the points are arranged in rows.

Step S102, sampling echoes of a laser beam emitted for one time by at least two receiving blocks to obtain sampling data of the at least two receiving blocks for the laser beam emitted for one time respectively.

The LiDAR also includes a sampling module, which is used to sample the echoes of each emitted laser beam through this sampling module. In an embodiment, the sampling module comprises multiple receiving blocks, where different receiving blocks correspond to different emissions, and each receiving block is used to sample the echoes of the laser beam emitted for the corresponding emission. For example, after each emission of a laser beam, the receiving block corresponding to that emission enters the sampling mode to sample the echoes of the laser beam emitted in that emission, to obtain sampling data.

Wherein, the sampling module includes at least two receiving blocks corresponding to one emission. In an embodiment, for each emission in the multiple emissions of step S101, there are at least two receiving blocks corresponding in the sampling module. At least one receiving block in the sampling module corresponds to at least two adjacent emissions.

In the at least two receiving blocks corresponding to the laser beam emitted for one time, the first receiving block corresponds a laser beam emitted for the N^{th} time and a laser beam emitted for the (N+1)^{th} time, and is configured to sample the corresponding laser beam. In an embodiment, the first receiving block can also correspond to the laser beam emitted for the (N+2)^{th} time.

In the at least two receiving blocks corresponding to the laser beam emitted for one time, the second receiving block is configured to sample the laser beam emitted for the N^{th} time but is not configured to sample the laser beam emitted for the (N+1)^{th} time, where N is an integer greater than or equal to 1. In an embodiment, in the case where N is greater than 1, the second receiving block is also configured to sample a laser beam emitted for the (N−1)^{th} time. In an embodiment, in the case where N is greater than 2, the second receiving block is further configured to sample the laser beam emitted for the (N−2)^{th} time.

In step S103, based on the sampling data of the at least two receiving blocks for the laser beam emitted for one time respectively, obtaining a point cloud data of the at least two receiving blocks corresponding to the laser beam emitted for one time corresponding to the at least two receiving blocks respectively.

After the first receiving block obtaining the sampling data corresponding to the laser beam emitted for one time, the point cloud data of the first receiving block corresponding to this emission can be obtained based on this sampling data. The same applies to other receiving blocks. The point cloud data may include at least one of distance, azimuth, reflectivity, or light spot area information, used to characterize the target object reflecting the laser beam emitted for that time.

Step S104, generating a frame of point cloud data based on the point cloud data of the laser beam emitted for one time corresponding to at least one of the receiving blocks.

In step S101, after emitting laser beams multiple times, point cloud data corresponding to at least one laser beam emitted for one time for each receiving block in the sampling module can be obtained, including point cloud data corresponding to at least two adjacent laser beams for some receiving blocks. Based on these point cloud data, a frame of point cloud data can be generated.

In some embodiments, the echo of a laser beam emitted for one time are sampled by at least two receiving blocks, with one receiving block sampling echoes from adjacent emissions at least twice. This configuration ensures that the echoes of the laser beam emitted for that time can be collected by the receiving blocks in the sampling module while keeping the number of receiving blocks in the sampling module relatively low, which helps reduce the cost of LiDAR systems and contributes to miniaturization.

In the case of the laser beams hitting objects in multiple emissions, each receiving block in at least some of the receiving blocks will generate at least two sets of point cloud data corresponding to at least two emissions of the laser beams within a certain time interval, with a high probability that the laser beams emitted at least twice within the same time interval will hit the same object successively. In an embodiment, for each receiving block in the at least some receiving blocks, the at least two sets of point cloud data corresponding to at least two emissions within a certain time interval are compressed into one point cloud data, which can reduce the amount of point cloud data and consequently decrease the consumption of bandwidth resources, while also maintaining a minimal amount of information loss.

In an embodiment, in step S104, generating a frame of point cloud data based on the point cloud data of the laser beam emitted for one time corresponding to at least one of the receiving blocks includes: for the first receiving block among the at least two receiving blocks, fusing point cloud data of the first receiving block corresponding to respective laser beams emitted in a preset time interval into compressed point cloud data corresponding to the preset time interval; and generating a frame of point cloud data based on the compressed point cloud data of the first receiving block corresponding to the preset time interval.

In an embodiment, there are various settings for the preset time interval. For example, in an embodiment of emitting laser beams multiple times along a row at different azimuth angles in step S101, the preset time interval is at least a part of the emission time interval corresponding to the laser beams emitted along the row. The preset time interval can be the emission time interval corresponding to the laser beams emitted along the row, or a part of the emission time interval corresponding to the laser beams emitted along the row, such as for each predetermined number of laser beams emitted along the row, the emission time interval of the predetermined number of laser beams is considered as a preset time interval.

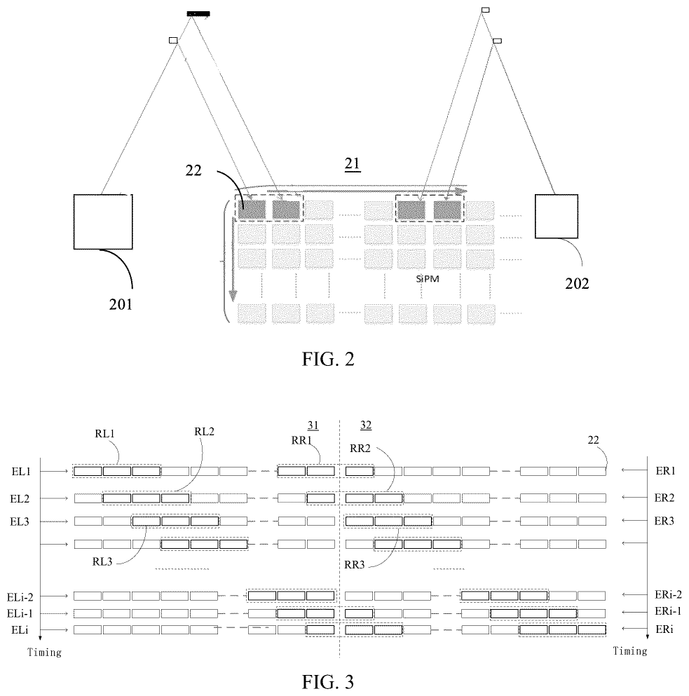

FIG. 2 is a schematic diagram of an embodiment of the emitting module and sampling module of the LiDAR. FIG. 3 is a schematic diagram of the operational timing relationship of the emitting module and sampling module shown in FIG. 2. As shown in FIG. 2, the emitting module of the LiDAR includes a first emitting unit 201 and a second emitting unit 202. In each emission, the first emitting unit 201 and the second emitting unit 202 are used to simultaneously emit a laser beam respectively. The sampling module includes a receiving block array 21, which comprises multiple rows of receiving blocks.

The emitting module emits laser beams for scanning sequentially along different rows. The receiving blocks of different rows correspond to the scanning of different rows in a one-to-one correspondence. Each row of receiving blocks is used to sample the echoes of the laser beams emitted during the scanning of the corresponding row. In each scan line, for each emission, three receiving blocks are used to sample each of the two laser beams emitted in that emission. FIG. 3 illustrates the operational state changes of the first receiving block row 22 of the receiving block array in different emissions during the first row scan of the emitting module.

The receiving block row 22 includes two parts of receiving blocks located in the left and right regions 31 and 32 of the receiving block array, where the receiving blocks located in region 31 are mainly used to sample echoes of the laser beam emitted by the first emitting unit 201, and the receiving blocks located in region 32 are mainly used to sample echoes of the laser beam emitted by the second emitting unit 202.

As shown in FIG. 2, for the first emission of the first row scanning corresponding to the emitting module, the echo of the laser beam EL1 emitted by the first emitting unit is sampled by the first˜third receiving blocks RL1 on the left side of the first row, and the echo of the laser beam ER1 emitted by the second emitting unit is sampled by three receiving blocks RR1, including the last two receiving blocks in region 31 and the first receiving block in region 32. Each receiving block in receiving blocks RL1 is used to obtain a corresponding point cloud data based on the sampling data of the echo of the laser beam EL1. Each receiving block in receiving blocks RR1 is used to obtain a corresponding point cloud data based on the sampling data of the echo of the laser beam ER1.

For the second emission of the first row scanning corresponding to the emitting module, the echo of the laser beam EL2 emitted by the first emitting unit are sampled by the 2nd to 4^{th} receiving blocks on the left side of the first row, and the echo of the laser beam ER2 emitted by the second emitting unit is sampled by the last receiving block in region 31 and the first two receiving blocks in region 32, totaling three receiving blocks. Each receiving block in the receiving block RL2 is used to obtain a corresponding point cloud data based on the sampling data of the echo of the laser beam EL2. Each receiving block in the receiving block RR2 is used to obtain a corresponding point cloud data based on the sampling data of the echo of the laser beam ER2.

For the third emission of the first row scanning corresponding to the emitting module, the echo of the laser beam EL3 emitted by the first emitting unit is sampled by the 3rd to 5^{th} receiving modules RL3 on the left side of the first row, and the echo of the laser beam ER3 emitted by the second emitting unit is sampled by three receiving modules RR3 in region 32, including the 1st to 3rd receiving blocks. Each receiving block in the receiving blocks RL3 is used to obtain a corresponding point cloud data based on the sampling data of the echo of the laser beam EL3. Each receiving block in the receiving blocks RR3 is used to obtain a corresponding point cloud data based on the sampling data of the echo of the laser beam ER3.

Until the i^{th} emission of the first row scanning corresponding to the emitting module (also the last emission in a row scan), the echo of the laser beam ELi emitted by the first emitting unit is sampled by the last receiving block in region 31 and the first two receiving blocks in region 32, totaling three receiving blocks RLi in the first row. The echo of the laser beam ERi emitted by the second emitting unit is sampled by the last three receiving blocks RRi in region 32. Each receiving block in RLi is used to obtain a corresponding point cloud data based on the sampling data of the echo of the laser beam ELi. Each receiving block in RRi is used to obtain a corresponding point cloud data based on the sampling data of the echo of the laser beam ERi.

Taking the emission time interval as the time interval emitted in a row as an example, the fusion of each portion of point cloud data corresponding to each emission of laser beams in the preset time interval by each receiving block in the receiving block row 22 into compressed point cloud data corresponding to the preset time interval refers to: compressing the point cloud data of all emissions of laser beams sampled by that receiving block in that row emission into one compressed point cloud data.

In the leftmost receiving block in the receiving block row 22, corresponding to one emission within a preset time interval, the point cloud data of this receiving block is directly output.

The second receiving block on the left side in the receiving block row 22 corresponds to two emissions within a preset time interval, therefore the point cloud data corresponding to these two emissions from this receiving block is compressed into a point cloud data output.

The third receiving block on the left side in receiving block row 22 corresponds to three emissions within a preset time interval, therefore the point cloud data corresponding to these three emissions is compressed into one point cloud data for output.

The last receiving block on the left in the receiving block row 22 corresponds to five emissions (laser beams ER1, ER2, ELi−2, ELi−1, and ELi) within a preset time interval. Therefore, the five point cloud data corresponding to these five emissions is compressed into one point cloud data for output. The same applies to the other receiving blocks in row 22.

There are various ways in which the point cloud data corresponding to each receiving block for each emission within a preset time interval is compressed. In some embodiments, after obtaining all the point cloud data of all receiving blocks in the sampling module, software is used to compress the point cloud data of each receiving block. In other examples, hardware can be used to compress the point cloud data of each receiving block.

For example, before forming a frame of point cloud, each point cloud data corresponding to each emission within a preset time interval for a receiving block is compressed into one point cloud data using hardware. In an embodiment, after the preset time interval, each point cloud data corresponding to each emission within the preset time interval for each receiving block can be compressed into one point cloud data in a one-time manner. Alternatively, due to sufficient time gaps between adjacent emissions, a serial processing approach can be utilized. After obtaining the point cloud data corresponding to each emission of the receiving block within the preset time interval, the hardware compresses the point cloud data of that emission for the receiving block with the point cloud data of the previous emission within that preset time interval into one point cloud data. This process continues until compressing the point cloud data of the last emission within the preset time interval for the receiving block with the point cloud data of the previous emission within that preset time interval into one point cloud data, resulting in one compressed point cloud data for the receiving block within that preset time interval.

In an embodiment, taking the first receiving block as an example, compressing the respective point cloud data of the first receiving block corresponding to laser beams emitted at various times within a preset time interval into a single point cloud data may include: sequentially storing the respective point cloud data of the first receiving block corresponding to laser beams emitted at various times within the preset time interval into a buffer, wherein before the i^{th} time of storing into the buffer, the point cloud data obtained at the i^{th} time is fused with the point cloud data stored in the buffer at the (i−1)^{th} time into a single point cloud data, and stored into the buffer at the i^{th} time, where i is an integer greater than 1, and the point cloud data obtained at the i^{th} time corresponds to the point cloud data of the first receiving block for the i^{th} laser beam emitted within the preset time interval.

In an embodiment, before storing the data for the i^{th} time in the buffer, the point cloud data of the first receiving block stored in the buffer at the (i−1)^{th} time is released, which can reduce the storage resources occupied by the point cloud data. In an embodiment, the buffer comprises at least two partitions, where the number of partitions is the same as the number of receiving blocks, and each partition is used to store point cloud data corresponding to one of the receiving blocks. In an embodiment, where the preset time interval corresponds to the emission time interval of a row, the number of partitions in the buffer is the same as the number of receiving blocks in the row corresponding to that emission. The point cloud data corresponding to the receiving blocks in the row is stored in the buffer in a serial manner.

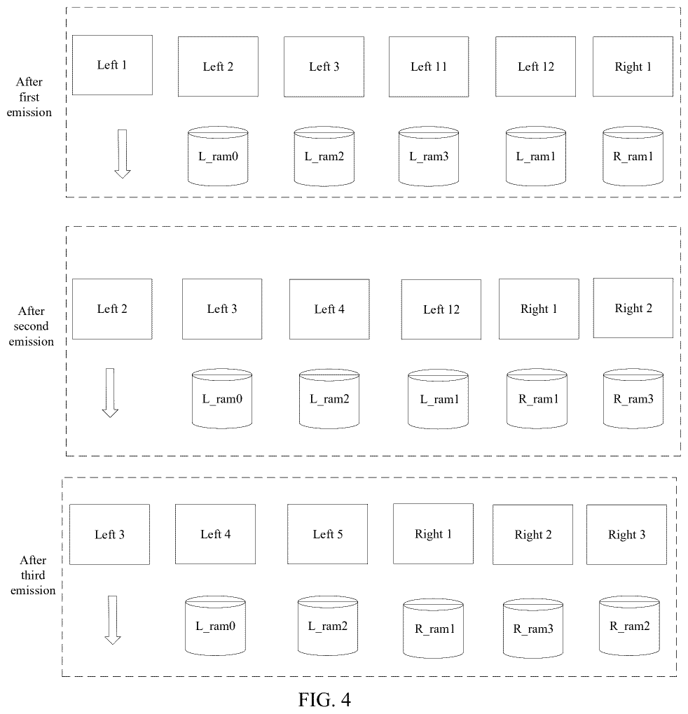

Reference to FIGS. 4 to 7, which utilizes a buffer of a LiDAR to compress the point cloud data of the receiving block row 22 shown in FIG. 3. In the embodiments shown in FIGS. 4 to 7, the emission time interval corresponding to the laser beams emitted in a row as shown in FIG. 3 is taken as an example of the preset time interval.

As the leftmost and rightmost receiving blocks in the receiving block row 22 correspond to only one emission in the preset time interval, after obtaining the point cloud data corresponding to the leftmost and rightmost receiving blocks for one emission in the preset time interval, there is no need to store it in the buffer. It can be directly output for forming a frame of point cloud. For the other receiving blocks in the receiving block row 22, each of which corresponds to at least two emissions in the preset time interval, for each receiving block in this group, after obtaining the point cloud data corresponding to the first emission in the preset time interval for that receiving block, the point cloud data is directly stored in the buffer. Then, after obtaining the point cloud data for each subsequent emission in the preset time interval for that receiving block, the previously stored point cloud data is read out, fused with the corresponding current emission point cloud data, and then written back into the buffer. In an embodiment, the previously stored point cloud data can be released from the buffer.

As shown in FIG. 4, FIG. 4 is a schematic diagram of the compression process of point cloud data corresponding to the first three emissions in a row of emission as in FIG. 3. Taking the receiving block row 22 as an example, which includes 12 receiving blocks located in region 31 and 12 receiving blocks located in region 32, in the following description, the left i block refers to the i^{th} receiving block in region 31 of the receiving block row 22, and the right i block refers to the i^{th} receiving block in region 32 of the receiving block row 22.

After the first emission, the point cloud data corresponding to the left 1 block is output directly without compression, while the point cloud data corresponding to the left 2 block is stored in partition L_ram0 of the buffer, and the point cloud data corresponding to the left 3 block is stored in partition L_ram2 of the buffer. The point cloud data corresponding to the left 11 block is stored in partition L_ram3, the point cloud data corresponding to the left 12 block is stored in partition L_ram1, and the point cloud data corresponding to the right 1 block is stored in partition R_ram1.

After the second emission, due to the fact that the left 2 block corresponds to only two emissions in the preset time interval, the point cloud data corresponding to the second emission of the left 2 block is compressed with the last stored point cloud data corresponding to the left 2 block read from partition L_ram0, and output as the final compressed point cloud data corresponding to the left 2 block, while releasing partition L_ram0. The point cloud data corresponding to the second emission of the left 3 block is compressed and processed with the last stored point cloud data corresponding to the left 3 block read from partition L_ram2, then stored in the just-released partition L_ram0, while releasing partition L_ram2. The point cloud data corresponding to the left 4 block which is the first-time received is stored in the just-released partition L_ram2. The point cloud data corresponding to the left 12 block is compressed with the last stored point cloud data corresponding to the left 12 block read from partition L_ram1 and then stored back in partition L_ram1. The point cloud data corresponding to the right 1 block is compressed with the last stored point cloud data corresponding to the right 1 block after being read from partition R_ram1 and then stored back in partition R_ram1; the point cloud data corresponding to the right 2 block which is the first-time received is stored in partition R_ram3.

After the third emission, the point cloud data corresponding to the left 3 block is compressed with the last stored point cloud data corresponding to the left 3 block read from partition L_ram0, and output as the final compressed point cloud data corresponding to the left 3 block, while releasing partition L_ram0. The point cloud data corresponding to the left 4 block is compressed and processed with the last stored point cloud data corresponding to the left 4 block read from partition L_ram2, then stored in the just-released partition L_ram0, while releasing partition L_ram2. The point cloud data corresponding to the left 5 block, which is first received, is stored in the just released partition L_ram2. The point cloud data corresponding to the right 1 block is compressed and processed with the last stored point cloud data corresponding to the right 1 block read from partition R_ram1, then stored again in partition R_ram1. The point cloud data corresponding to the right 2 block is compressed and processed with the last stored point cloud data corresponding to the right 2 block read from partition R_ram3, then stored again in partition R_ram3. The point cloud data corresponding to the right 3 block, which is first received, is stored in partition R_ram2.

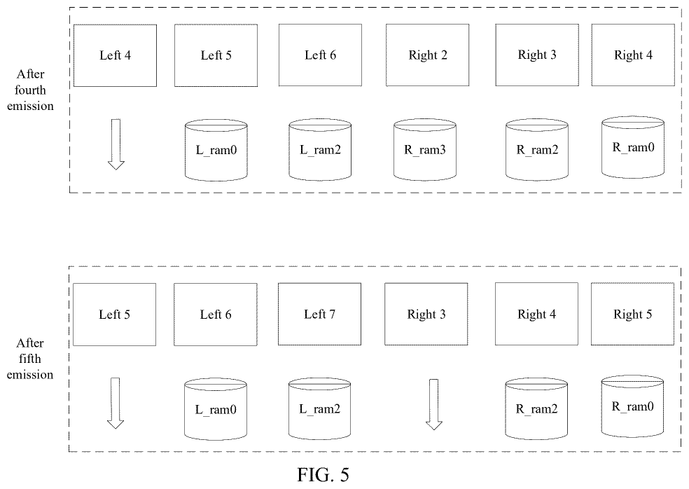

As shown in FIG. 5, FIG. 5 is a schematic diagram of the compression process of point cloud data corresponding to the 4^{th} to 8^{th} emissions in a row of the receiving block row 22 as shown in FIG. 3.

After the fourth emission, the point cloud data corresponding to the left 4 block is compressed with the last stored point cloud data corresponding to the left 4 block read from partition L_ram0, and output as the final compressed point cloud data corresponding to the left 4 block, while releasing partition L_ram0. The point cloud data corresponding to the left 5 block is compressed and processed with the last stored point cloud data corresponding to the left 5 block read from partition L_ram2, then stored in the just-released partition L_ram0, while releasing partition L_ram2. The point cloud data corresponding to the left 6 block, which is first received, is stored in the just released partition L_ram2. The point cloud data corresponding to the right 2 block is compressed and processed with the last stored point cloud data corresponding to the right 2 block read from partition R_ram3, then stored again in partition R_ram3. The point cloud data corresponding to the right 3 block is compressed and processed with the last stored point cloud data corresponding to the right 3 block read from partition R_ram2, then stored again in partition R_ram2. The point cloud data corresponding to the right 4 block, which is first received, is stored in partition R_ram0.

The first 4 scans involve receiving data from 6 blocks and outputting 1 block. Starting from the fifth scan, it will switch to receiving data from 6 blocks and outputting 2 blocks.

After the fifth emission, the point cloud data corresponding to the left 5 block is compressed with the last stored point cloud data corresponding to the left 5 block read from partition L_ram0, and output as the final compressed point cloud data corresponding to the left 5 block, while releasing partition L_ram0. The point cloud data corresponding to the left 6 block is compressed and processed with the last stored point cloud data corresponding to the left 6 block read from partition L_ram2, then stored in the just-released partition L_ram0, while releasing partition L_ram2. The point cloud data corresponding to the left 7 block, which is first received, is stored in the just released partition L_ram2. The point cloud data corresponding to the right 3 block is compressed with the last stored point cloud data corresponding to the right 3 block read from partition R_ram2, and output as compressed point cloud data corresponding to the right 3 block, while releasing partition R_ram2. The point cloud data corresponding to the right 4 block is compressed and processed with the last stored point cloud data corresponding to the right 4 block read from partition R_ram0, then stored in the just-released partition R_ram2.

The point cloud data corresponding to the right 5 block which is first received is stored in partition R_ram0.

The compression process after the sixth to eighth emissions is similar to the compression process after the fifth emission, and the same RAM is used.

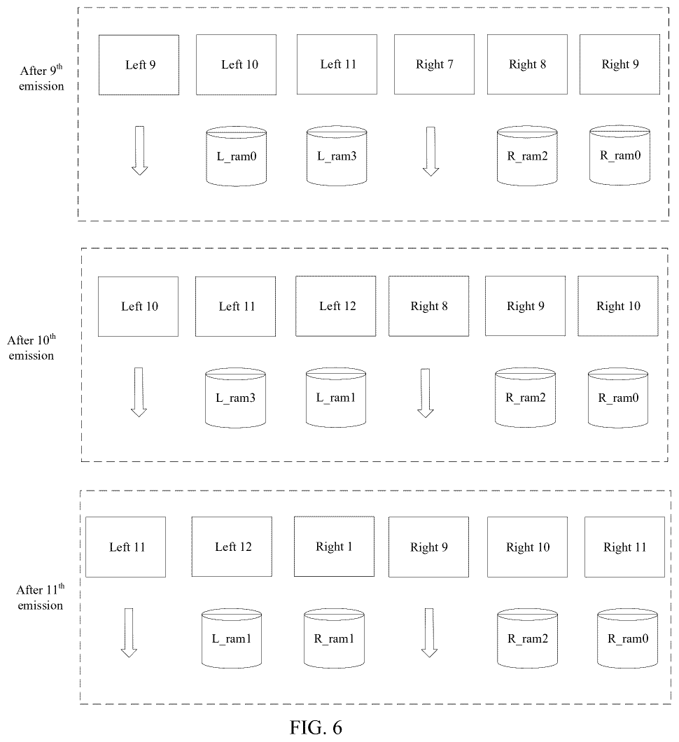

FIG. 6 is a schematic diagram of the compression process of point cloud data corresponding to the 9^{th}-11^{th} emissions in a row of the receiving block row 22 as shown in FIG. 3.

After the 9^{th} emission, the point cloud data corresponding to the left 9 block is compressed with the last stored point cloud data corresponding to the left 9 block read from partition L_ram0, and output as the final compressed point cloud data corresponding to the left 9 block, while releasing partition L_ram0. The point cloud data corresponding to the left 10 block is compressed and processed with the last stored point cloud data corresponding to the left 10 block read from partition L_ram2, then stored in the just-released partition L_ram0, while releasing partition L_ram2. The point cloud data corresponding to the left 11 block is compressed with the point cloud data corresponding to the first emission of the left 11 block from partition L_ram3, and then stored in partition L_ram3. The point cloud data corresponding to the right 7 block is compressed and processed with the last stored point cloud data corresponding to the right 7 block read from partition R_ram2, output as the final compressed point cloud data corresponding to the right 7 block, while releasing partition R_ram2. The point cloud data corresponding to the right 8 block is compressed and processed with the last stored point cloud data corresponding to the right 8 block read from partition R_ram0, then stored again in partition R_ram2. The point cloud data corresponding to the right 9 block, which is first received, is stored in partition R_ram0.

The compression process after the 10^{th} to 11^{th} emissions is similar to the compression process after the 9^{th} emission, and the same RAM is used.

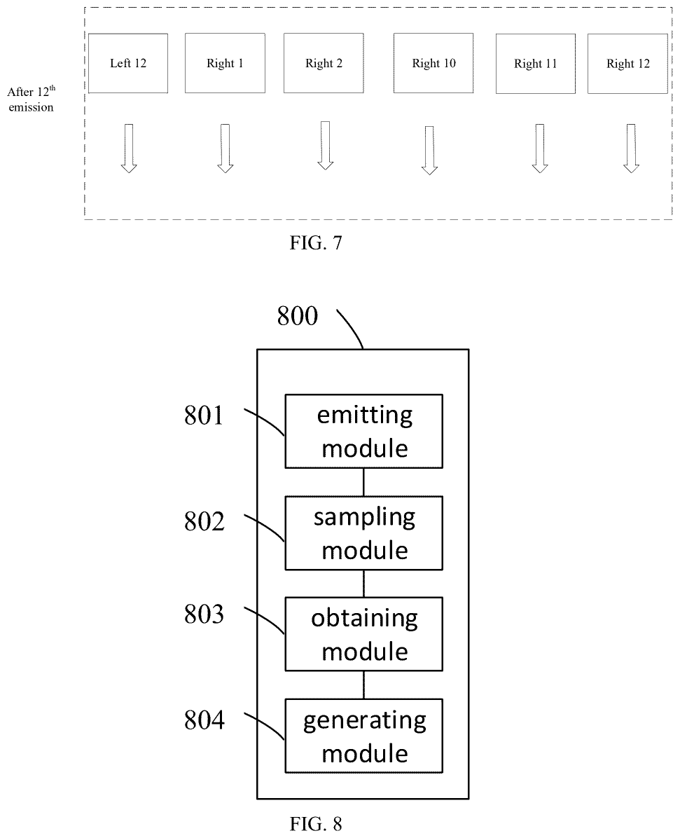

FIG. 7 is a schematic diagram of the compression process of point cloud data corresponding to the 12^{th} emission in a row of the receiving block row 22 as shown in FIG. 3.

After the 12^{th} emission, the compressed point cloud data of the 6 receiving blocks are all output. Among them, the point cloud data corresponding to the left 12 block is compressed with the last stored point cloud data corresponding to the left 12 block read from partition L_ram1, and output as the final compressed point cloud data corresponding to the left 12 block. The point cloud data corresponding to the right 1 block is compressed with the last stored point cloud data corresponding to the right 1 block read from partition R_ram1, and output as the final compressed point cloud data corresponding to the right 1 block. The point cloud data corresponding to the right 2 block is compressed with the last stored point cloud data corresponding to the right 2 block read from partition R_ram3, and output as the final compressed point cloud data corresponding to the right 2 block. The point cloud data corresponding to the right 10 block is compressed with the last stored point cloud data corresponding to the right 10 block read from partition R_ram2, and output as the final compressed point cloud data corresponding to the right 10 block. The point cloud data corresponding to the right 11 block is compressed with the last stored point cloud data corresponding to the right 11 block read from partition R_ram0, and output as the final compressed point cloud data corresponding to the right 11 block. The point cloud data corresponding to the right 12 block is directly output without the need for fusion.

In some examples, each receiving block may include at least two receiving units, and all receiving units within each receiving block enter the sampling working state when the receiving block enters the sampling working state. The sampling data of each receiving block includes the sampling data of each receiving unit. Taking the first receiving block as an example, the sampling data of the first receiving block for the laser beam emitted for one time includes the sampling data of multiple receiving units within the first receiving block for the laser beam emitted for one time. The receiving unit can be a pixel in the receiving block.

The point cloud data corresponding to different emissions within a preset time interval of a receiving block specifically includes the point cloud data corresponding to different emissions within the preset time interval for each receiving unit in the receiving block. Taking the first receiving unit among the at least two receiving units as an example, in step S103 of the embodiment shown in FIG. 1, based on the sampling data of the at least two receiving blocks for the laser beam emitted for one time, the point cloud data corresponding to the laser beam emitted for one time by the at least two receiving blocks is obtained. This includes: based on the sampling data of the first receiving unit for the laser beam emitted for one time, obtaining a group of point cloud data corresponding to the first receiving unit for the laser beam emitted for one time; in step S104, compressing the various portions of point cloud data of the first receiving block corresponding to each emission of the laser beam in the preset time interval into a single point cloud data, which involves compressing the various groups of point cloud data of the first receiving unit corresponding to each emission of the laser beam in the preset time interval into a single group of point cloud data.

In embodiments shown in FIGS. 4 to 7, each partition in the buffer corresponding to each receiving block includes a subpartition corresponding to each receiving unit of that receiving block. When compressing groups of point cloud data corresponding to the first receiving unit for each laser beam emitted in a preset time interval into a compressed group of point cloud data, the groups of point cloud data corresponding to the first receiving unit for each laser beam emitted in the preset time interval are sequentially stored in the corresponding subpartitions of the buffer. Prior to storing data into the buffer for the i^{th} time, the group of point cloud data obtained at the i^{th} time is fused with the group of point cloud data stored in the buffer at the (i−1)^{th} time to form a fused group of point cloud data, which is used as the data stored in the buffer at the i^{th} time or as part of the output of the fused point cloud data, i^{th} is an integer greater than or equal to 1. Here, the group of point cloud data obtained at the i^{th} time corresponds to the point cloud data of the first receiving unit for the i^{th} laser beam emitted in the preset time interval.

There are multiple methods for fusing a group of point cloud data obtained at the i^{th} time with a group of point cloud data stored in the buffer at the (i−1)^{th} time into a group of fused point cloud data.

In an embodiment, obtaining a difference between a group of point cloud data obtained at the i^{th} time and a group of point cloud data stored in the buffer at the (i−1)^{th} time, when the difference is less than a preset difference, the weighted sum of the group of point cloud data obtained at the i^{th} time and the group of point cloud data stored in the buffer at the (i−1)^{th} time is taken as the fused point cloud data. In an embodiment, when the difference is not less than the preset difference, the fused point cloud data is determined based on the light spot area of the group of point cloud data obtained at the i^{th} time and the light spot area of the group of point cloud data stored in the buffer at the (i−1)^{th} time.

The method of determining whether the difference between a group of point cloud data obtained at the i^{th} time and a group of point cloud data stored in the buffer at the (i−1)^{th} time is less than a preset difference has various aspects. For example, the group of point cloud data obtained at the i^{th} time and the group of point cloud data stored in the buffer at the (i−1)^{th} time include at least one of distance, reflectivity, and light spot area, where the light spot area is determined based on the optical energy sampled by the first receiving unit for a laser beam emitted for one time. The determination of whether the difference between the group of point cloud data obtained at the i^{th} time and the group of point cloud data stored in the buffer at the (i−1)^{th} time is less than a preset difference can be based on at least one of the following criteria:
The difference between the distance value obtained at the i^{th} time and the distance value stored in the buffer at the (i−1)^{th} time is less than a preset distance value;
The difference between the reflectivity value obtained at the i^{th} time and the reflectivity value stored in the buffer at the (i−1)^{th} time is less than a preset distance value;
The difference between the light spot area value obtained at the i^{th} time and the light spot area value stored in the buffer at the (i−1)^{th} time is less than a preset distance value.

In an embodiment, when the light spot area in the group of point cloud data obtained at the i^{th} time is not less than the light spot area in the group of point cloud data stored in the buffer at the (i−1)^{th} time, perform at least one of the following:
When the value of the light spot area or distance in the group of point cloud data stored in the buffer at the (i−1)^{th} time is 0, the group of point cloud data obtained at the i^{th} time is determined as the group of fused point cloud data;
When the light spot area in the group of point cloud data obtained at the i^{th} time is greater than the saturation area, the light spot area in the group of point cloud data stored in the buffer at the (i−1)^{th} time is greater than the preset area, the difference between the light spot area in the group of point cloud data obtained at the i^{th} time and the light spot area in the group of point cloud data stored in the buffer at the (i−1)^{th} time is less than a preset area comparison threshold, and the value of the distance in the group of point cloud data stored in the buffer at the (i−1)^{th} time is not 0, then the group of point cloud data stored in the buffer at the (i−1)^{th} time is determined as the fused point cloud data.

When the light spot area in the group of point cloud data obtained at the i^{th} time is not greater than the saturation area, or the light spot area of the group of point cloud data stored in the buffer at the (i−1)^{th} time is not greater than the preset area, or the difference between the light spot area of the group of point cloud data obtained at the i^{th} time and the light spot area of the group of point cloud data stored in the buffer at the (i−1)^{th} time is not less than the preset area comparison threshold, and the difference between the distance of the group of point cloud data obtained at the i^{th} time and the distance of the group of point cloud data stored in the buffer at the (i−1)^{th} time is less than the preset distance comparison threshold, or the value of the distance of the group of point cloud data stored in the buffer at the (i−1)^{th} time is 0 and the light spot area is not 0, then the group of point cloud data obtained at the i^{th} time is determined as the fused point cloud data.

For example, when the light spot area in the group of point cloud data obtained at the i^{th} time is smaller than the light spot area in the group of point cloud data stored in the buffer at the (i−1)^{th} time, at least one of the following is executed:
When the light spot area in a group of point cloud data stored in the buffer at the (i−1)^{th} time is greater than the saturation area, and the distance in a group of point cloud data obtained at the i^{th} time is not equal to 0, then the group of point cloud data obtained at the i^{th} time is determined as the fused point cloud data;
When the light spot area in a group of point cloud data stored in the buffer at the (i−1)^{th} time is not greater than the saturation area, or when the distance in a group of point cloud data obtained at the i^{th} time is 0, the group of point cloud data stored in the buffer at the (i−1)^{th} time is determined as the fused point cloud data.

In an embodiment, in the example where a group of point cloud data obtained at the i^{th} time includes a light spot area, before determining the difference between the group of point cloud data obtained at the i^{th} time and the group of point cloud data stored in the buffer at the (i−1)^{th} time, it is further determined that the light spot area of the group of point cloud data obtained at the i^{th} time is not less than the preset area. In an embodiment, when storing the group of point cloud data of the first receiving unit corresponding to respective laser beams in the preset time interval into the buffer in sequence, it is determined whether the light spot area of the group of point cloud data obtained at the i^{th} time is less than the preset area. When it is determined that the light spot area of the group of point cloud data obtained at the i^{th} time is less than the preset area, the light spot area of the group of point cloud data stored in the buffer at the (i−1)^{th} time is checked to see if it is less than the preset area.

When the light spot area in the group of point cloud data stored in the buffer at the (i−1)^{th} time is less than the preset area, the group of point cloud data obtained at the i^{th} time is stored in the buffer at the i^{th} time, and/or when the light spot area in the group of point cloud data stored in the buffer at the (i−1)^{th} time is not less than the preset area, the group of point cloud data stored in the buffer at the (i−1)^{th} time is stored in the buffer at the i^{th} time.

The following is an explanation of the method for fusing a group of point cloud data obtained at the i^{th} time with a group of point cloud data stored in the buffer at the (i−1)^{th} time into a fused group of point cloud data in an embodiment. In a LiDAR system, threshold values csr_dist_th and csr_squa_th are pre-stored for comparison, as well as a minimum spot area abs_squa_th representing valid light spots, and a saturated spot area csr_satu_t. In the group of point cloud data obtained at the i^{th} time, it includes Sc (representing the spot area value), Dc (representing the distance value), and Rc (representing the reflectivity value). In the group of point cloud data stored in the buffer at the (i−1)^{th} time, it includes Sl (representing the spot area value), Dl (representing the distance value), and Rl (representing the reflectivity value).

In an embodiment, if Sc>=abs_squa_th, then:
When |Dc−Dl|<=csr_dist_th and |Sc−Sl|<=csr_squa_th, select {(Dc+Dl)/2,
(Rc+Rl)/2, (Sc+Sl)/2} as the fused point cloud data;
When |Dc−Dl|>csr_dist_th or |Sc−Sl|>csr_squa_th, compare Sc and Sl:

### (1) If Sc>=Sl,

If Dl or Sl is zero, select {Dc, Rc, Sc} as the fused point cloud data;
if Sc>csr_satu_t, Sl>abs_squa_th, |Sc−Sl|<=csr_squa_th, and Dl is not equal to zero, then select {Dl, Rl, Sl} as the fused point cloud data; Otherwise, select {Dc, Rc, Sc} as the fused point cloud data;

### (2) If Sc<Sl,

If Sl>csr_satu_t and Dc is not equal to zero, then select {Dc, Rc, Sc} as the fused point cloud data.
Otherwise, select {Dl, Rl, Sl} as the fused point cloud data.

In an embodiment, if Sc<abs_squa_th, compare Sl with abs_squa_th:
1) If Sl<abs_squa_th, select {Dc, Rc, Sc} as the fused point cloud data.
2) Otherwise, select {Dl, Rl, Sl} as the fused point cloud data.

In an embodiment, a sampling data processing apparatus is provided. As shown in FIG. 8, FIG. 8 is a schematic diagram of an embodiment of the sampling data processing apparatus. The sampling data processing apparatus 800 comprises: an emitting module 801 for emitting laser beams multiple times; sampling module 802 comprises at least two receiving blocks, where the at least two receiving blocks are used to sample echoes of a laser beam emitted for one time to obtain sampling data of the at least two receiving blocks for the laser beam emitted for one time respectively. In the at least two receiving blocks, the first receiving block is used to sample a laser beam emitted for the Nth time and a laser beam emitted for the (N+1)th time, while the second receiving block is used to sample a laser beam emitted for the Nth time but not for the (N+1)th time, where N is an integer greater than or equal to 1.

Obtaining module 803, for obtaining a point cloud data corresponding to the laser beam emitted for one time by the at least two receiving blocks respectively based on the sampling data of the at least two receiving blocks for the laser beam emitted for one time respectively;

Generating module 804 is used to generate a frame of point cloud data based on the point cloud data of the laser beam emitted for one time corresponding to at least one of the receiving blocks.

In an embodiment, the generating module 804, when generating a frame of point cloud data based on the point cloud data of the laser beam emitted for one time corresponding to at least one of the receiving blocks, performs: for the first receiving block, the first receiving block corresponds to point cloud data of respective laser beams emitted in a preset time interval, which is fused into compressed point cloud data corresponding to the preset time interval; according to the first receiving block corresponding to the compressed point cloud data of the preset time interval, a frame of point cloud data is generated.

In an embodiment, the emitting module 801, when emitting laser beams for multiple times, used for: laser beams are emitted sequentially along a row at different azimuth angles, the difference between the maximum emission pitch angle and the minimum emission pitch angle of the laser beams emitted along a row is less than a preset angle, the preset time interval is at least a part of an emission time interval corresponding to the laser beams emitted along the row.

In an embodiment, the generating module 804, when compressing the point cloud data of the first receiving block corresponding to respective laser beams emitted in a preset time interval into compressed point cloud data corresponding to the preset time interval, performs:
store the point cloud data of the first receiving block corresponding to respective laser beams emitted in the preset time interval into the buffer in sequence; before the ith time of storing the point cloud data into the buffer, the point cloud data obtained at the ith time is fused with the point cloud data stored in the buffer at the (i−1)^{th} time to form a fused point cloud data, and the fused point cloud data is used as the point cloud data stored in the buffer at the ith time or as part of the compressed point cloud data, where i is an integer greater than 1. The point cloud data obtained at the ith time corresponds to the laser beam emitted for the ith time in the preset time interval by the first receiving block.

In an embodiment, the generating module 804, when compressing the point cloud data of the first receiving block corresponding to respective laser beams emitted in a preset time interval into compressed point cloud data corresponding to the preset time interval, further performs: before storing the data of the first receiving block in the buffer for the ith time, the point cloud data of the first receiving block stored in the buffer for the (i−1)^{th} time is released.

In an embodiment, the buffer includes at least two partitions, where a number of partitions in the buffer is the same as a number of receiving blocks, and each partition is used to store a point cloud data corresponding to one of the receiving blocks.

The point cloud data corresponding to at least two receiving blocks is stored in the buffer in a serial manner.

In an embodiment, the first receiving block comprises multiple receiving units, and the sampling data of the first receiving block for the laser beam emitted for one time includes sampling data of multiple receiving units in the first receiving block for the laser beam emitted for one time respectively, and the multiple receiving units comprise a first receiving unit.

The method involves obtaining a point cloud data of the laser beam emitted for one time corresponding to the at least two receiving blocks respectively based on the sampling data of the at least two receiving blocks for the laser beam emitted for one time respectively, including: obtain a group of point cloud data corresponding to the laser beam emitted for one time based on the sampling data of the first receiving unit for the laser beam emitted for one time.

The generating module 804, when compressing the point cloud data of the first receiving block corresponding to respective laser beams emitted in a preset time interval into compressed point cloud data corresponding to the preset time interval, comprises:

The first receiving unit corresponds to the respective groups of point cloud data corresponding to laser beams emitted at various times within the preset time interval, compressing them into a group of point cloud data.

In an embodiment, the method further includes compressing the point cloud data of the first receiving unit corresponding to respective laser beams emitted at each time within the preset time interval into a group of point cloud data, comprising: storing the point cloud data of the first receiving unit corresponding to respective laser beams emitted at each time within the preset time interval into the buffer in sequence, where, before storing the data for the i^{th} time in the buffer, the data obtained at the i^{th} time is fused with the data stored in the buffer at the (i−1)^{th} time to form a fused data set, which is then used as the data stored in the buffer at the i^{th} time or as part of the output of the compressed data, where i is an integer greater than 1, the group of point cloud data obtained at the i^{th} time is the point cloud data of the first receiving unit corresponding to the i^{th} laser beam emitted in the preset time interval.

In an embodiment, fusing a group of point cloud data obtained at the i^{th} time with a group of point cloud data stored in the buffer at the (i−1)^{th} time into a group of fused point cloud data comprises:
Obtaining the difference between the group of point cloud data obtained at the i^{th} time and the group of point cloud data stored in the buffer at the (i−1)^{th} time;
When the difference is less than a preset difference, the weighted sum of the group of point cloud data obtained at the i^{th} time and the group of point cloud data stored in the buffer at the (i−1)^{th} time is taken as the fused point cloud data.

In an embodiment, the point cloud data includes a light spot area, and the light spot area is determined based on the optical energy sampled by the first receiving unit for the laser beam emitted for one time.

The fusing the group of point cloud data obtained at the i^{th} time with the group of point cloud data stored in the buffer at the (i−1)^{th} time into a group of fused point cloud data comprises: when the difference is not less than the preset difference, the group of fused point cloud data is determined based on the light spot area of the group of point cloud data obtained at the i^{th} time and the light spot area of the group of point cloud data stored in the buffer at the (i−1)^{th} time.

In an embodiment, determining the fused point cloud data based on the light spot area in the group of point cloud data obtained at the i^{th} time and the light spot area in the group of point cloud data stored in the buffer at the (i−1)^{th} time includes: when the light spot area in the group of point cloud data obtained at the i^{th} time is not less than the light spot area in the group of point cloud data stored in the buffer at the (i−1)^{th} time, perform at least one of the following.

When the value of the light spot area or distance in the group of point cloud data stored in the buffer at the (i−1)^{th} time is 0, the group of point cloud data obtained at the i^{th} time is determined as the fused point cloud data.

When the light spot area in the group of point cloud data obtained at the i^{th} time is greater than the saturation area, the light spot area of the group of point cloud data stored in the buffer at the (i−1)^{th} time is greater than the preset area, the difference between the light spot area of the group of point cloud data obtained at the i^{th} time and the light spot area of the group of point cloud data stored in the buffer at the (i−1)^{th} time is less than a preset area comparison threshold, and the value of the distance of the group of point cloud data stored in the buffer at the (i−1)^{th} time is not 0, then the group of point cloud data stored in the buffer at the (i−1)^{th} time is determined as the group of fused point cloud data.

When the light spot area in the group of point cloud data obtained at the i^{th} time is not greater than the saturation area, or the light spot area of the group of point cloud data stored in the buffer at the (i−1)^{th} time is not greater than the preset area, or the difference between the light spot area of the group of point cloud data obtained at the i^{th} time and the light spot area of the group of point cloud data stored in the buffer at the (i−1)^{th} time is not less than the preset area comparison threshold, and the difference between the distance of the group of point cloud data obtained at the i^{th} time and the distance of the group of point cloud data stored in the buffer at the (i−1)^{th} time is less than the preset distance comparison threshold, or the value of the distance of the group of point cloud data stored in the buffer at the (i−1)^{th} time is 0 and the light spot area is not 0, then the group of point cloud data obtained at the i^{th} time is determined as the fused point cloud data.

In an embodiment, determining the fused point cloud data based on the light spot area in the group of point cloud data obtained at the i^{th} time and the light spot area in the group of point cloud data stored in the buffer at the (i−1)^{th} time includes:
When the light spot area in the group of point cloud data obtained at the i^{th} time is less than the light spot area in the group of point cloud data stored in the buffer at the (i−1)^{th} time, perform at least one of the following:
When the light spot area in a group of point cloud data stored in the buffer at the (i−1)^{th} time is greater than the saturation area, and the distance in a group of point cloud data obtained at the i^{th} time is not equal to 0, then the group of point cloud data obtained at the i^{th} time is determined as the fused point cloud data.

When the light spot area in a group of point cloud data stored in the buffer at the (i−1)^{th} time is not greater than the saturation area, or when the distance in a group of point cloud data obtained at the i^{th} time is 0, the group of point cloud data stored in the buffer at the (i−1)^{th} time is determined as the group of fused point cloud data.

In an embodiment, the group of point cloud data obtained at the i^{th} time includes a light spot area, and the light spot area is determined based on the optical energy sampled by the first receiving unit for the i^{th} laser beam in the preset time interval;

The step of obtaining a difference between the group of point cloud data obtained at the i^{th} time and the group of point cloud data stored in the buffer at the (i−1)^{th} time further comprises: make that the light spot area in the group of point cloud data obtained at the i^{th} time is not less than the preset area.

In an embodiment, storing the group of point cloud data of the first receiving unit corresponding to respective laser beams emitted in the preset time interval into the buffer in sequence may further comprise:
When it is determined that the light spot area in the group of point cloud data obtained at the i^{th} time is less than the preset area, determine whether the light spot area of the group of point cloud data stored in the buffer at the (i−1)^{th} time is less than the preset area;
When the light spot area in a group of point cloud data stored in the buffer at the (i−1)^{th} time is less than the preset area, the group of point cloud data obtained at the i^{th} time is stored in the buffer at the i^{th} time, and/or,
When the light spot area in a group of point cloud data stored in the buffer at the (i−1)^{th} time is not less than the preset area, the group of point cloud data stored in the buffer at the (i−1)^{th} time is stored into the buffer at the i^{th} time.

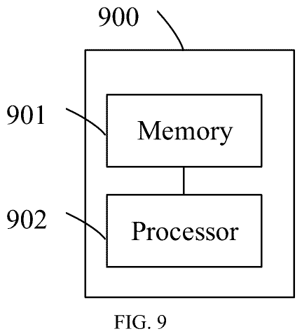

FIG. 9 is a schematic diagram of an embodiment of the LiDAR. The LiDAR 900 includes a memory 901 and a processor 902.

The processor 902 can be a Central Processing Unit (CPU), or it can be another general processor, Digital Signal Processor (DSP), Application-Specific Integrated Circuit (ASIC), Field-Programmable Gate Array (FPGA), or other programmable logic devices, discrete gates, or transistor logic devices, discrete hardware components, etc. The general processor can be a microprocessor or any conventional processor, etc.

The memory 901 may include various types of storage units, such as system memory, read-only memory (ROM), and permanent storage devices. Specifically, ROM can store static data or instructions required by the processor 902 or other modules of the computer. The permanent storage device can be a writable storage device that retains instructions and data even when the computer is powered off, making it a non-volatile storage device. In some embodiments, the permanent storage device may utilize high-capacity storage devices (such as magnetic or optical disks, flash memory) as the permanent storage medium. In other embodiments, the permanent storage device can be a removable storage device (such as floppy disks, optical drives). System memory can be a writable or volatile random access memory, such as dynamic random access memory (DRAM). System memory can store some or all of the instructions and data required by the processor during operation. Additionally, the memory 901 may comprise a combination of any computer-readable storage media, including various types of semiconductor storage chips (such as DRAM, SRAM, SDRAM, flash memory, programmable read-only memory), as well as disks and/or optical discs. In some embodiments, the memory 1000 may include removable storage devices that are readable and/or writable, such as compact discs (CDs), read-only digital versatile discs (DVD-ROM, dual-layer DVD-ROM), read-only Blu-ray discs, high-density optical discs, flash memory cards (such as SD cards, miniSD cards, Micro-SD cards, etc.), magnetic floppy disks, and the like. Computer-readable storage media do not include carriers and instantaneous electronic signals transmitted wirelessly or through wired means.

Executable code is stored in memory 901. When the executable code is processed by processor 902, the processor 902 can execute some or all of the methods described above.

What is claimed is:

1. A LIDAR data processing method, comprising:
emitting laser beams for multiple times;
sampling echoes of a laser beam emitted for one time by at least two receiving blocks, to obtain sampling data of the at least two receiving blocks for the laser beam emitted for one time respectively, wherein a first receiving block in the at least two receiving blocks is used to sample a laser beam emitted for an N^{th} time and a laser beam emitted for an (N+1)^{th} time, and a second receiving block in the at least two receiving blocks is used to sample a laser beam emitted for the N^{th} time but is not used to sample a laser beam emitted for the (N+1)^{th} time, and N is an integer greater than or equal to 1;
obtaining a point cloud data of the laser beam emitted for one time corresponding to the at least two receiving blocks respectively, based on the sampling data of the at least two receiving blocks for the laser beam emitted for one time respectively; and
generating a frame of point cloud data based on the point cloud data of the laser beam emitted for one time corresponding to at least one of the receiving blocks.

2. The method according to claim 1, wherein the generating a frame of point cloud data based on the point cloud data of the laser beam emitted for one time corresponding to at least one of the receiving blocks comprises:
for the first receiving block, fusing point cloud data of the first receiving block corresponding to respective laser beams emitted in a preset time interval into compressed point cloud data corresponding to the preset time interval; and
generating a frame of point cloud data based on the compressed point cloud data of the first receiving block corresponding to the preset time interval.

3. The method according to claim 2, wherein the emitting laser beams for multiple times comprises:
emitting laser beams along a row in sequence at different azimuth angles,
wherein a difference between a maximum emission pitch angle and a minimum emission pitch angle of the laser beams emitted along the row is less than a preset angle, and the preset time interval is at least a part of an emission time interval corresponding to the laser beams emitted along the row.

4. The method according to claim 2, wherein the fusing point cloud data of the first receiving block corresponding to respective laser beams emitted in a preset time interval into compressed point cloud data corresponding to the preset time interval comprises:
storing point cloud data of the first receiving block corresponding to respective laser beams in the preset time interval into a buffer in sequence,
wherein before the i^{th} time of storing the point cloud data into the buffer, point cloud data obtained at the i^{th} time is fused with point cloud data stored in the buffer at the (i−1)^{th} time into point cloud data, stored in the buffer at the i^{th} time, i is an integer greater than or equal to 1, and
wherein the point cloud data obtained at the i^{th} time is point cloud data of the first receiving block corresponding to an i^{th} laser beam in the preset time interval.

5. The method according to claim 4, wherein the fusing point cloud data of the first receiving block corresponding to respective laser beams emitted in a preset time interval into compressed point cloud data corresponding to the preset time interval further comprises:
releasing point cloud data of the first receiving block stored in the buffer at the (i−1)^{th} time before the i^{th} time of storing the point cloud data into the buffer.

6. The method according to claim 5, wherein
the buffer comprises at least two partitions, a number of the at least two partitions is the same as a number of the at least two receiving blocks, and each of the at least two partitions is used to store point cloud data of a corresponding one of the at least two receiving blocks, and
point cloud data of the at least two receiving blocks is stored in the buffer in a serial manner.

7. The method according to claim 2, wherein the first receiving block comprises a plurality of receiving units, and the sampling data of the first receiving block for the laser beam emitted for one time comprises sampling data of a plurality of the receiving units in the first receiving block for the laser beam emitted for one time respectively, and the plurality of receiving units comprise a first receiving unit, and
the obtaining the point cloud data of the laser beam emitted for one time corresponding to the at least two receiving blocks respectively based on the sampling data of the at least two receiving blocks for the laser beam emitted for one time respectively comprises:
obtaining a group of point cloud data of a first receiving unit corresponding to the laser beam emitted for one time based on the sampling data of the first receiving unit for the laser beam emitted for one time, and
the fusing point cloud data of the first receiving block corresponding to respective laser beams emitted in a preset time interval into compressed point cloud data corresponding to the preset time interval comprises:
compressing groups of point cloud data corresponding to the first receiving unit for respective laser beams emitted in the preset time interval into a compressed group of point cloud data.

8. The method according to claim 7, wherein the compressing groups of point cloud data corresponding to the first receiving unit for respective laser beams emitted in the preset time interval into a compressed group of point cloud data comprises:
storing point cloud data of the first receiving unit corresponding to respective laser beams in the preset time interval into the buffer in sequence,
wherein before the i^{th} time of storing the point cloud data into the buffer, point cloud data obtained at the i^{th} time is fused with point cloud data stored in the buffer at the (i−1)^{th} time into a group of fused point cloud data, and the group of fused point cloud data is used as point cloud data stored in the buffer at the i^{th} time or as part of the compressed point cloud data, and i is an integer greater than 1, and
wherein the point cloud data obtained at the i^{th} time is point cloud data of the first receiving unit corresponding to an i^{th} laser beam in the preset time interval.

9. The method according to claim 8, wherein the point cloud data obtained at the i^{th} time is fused with point cloud data stored in the buffer at the (i−1)^{th} time into a group of fused point cloud data comprises:
obtaining a difference between the point cloud data obtained at the i^{th} time and the point cloud data stored in the buffer at the (i−1)^{th} time, and
when the difference is less than a preset difference, obtaining a weighted sum of the point cloud data obtained at the i^{th} time and the point cloud data stored in the buffer at the (i−1)^{th} time as the group of fused point cloud data.

10. The method according to claim 9, wherein the point cloud data comprises a light spot area, and the light spot area is determined based on optical energy sampled by the first receiving unit for the laser beam emitted for one time, and
the point cloud data obtained at the i^{th} time is fused with point cloud data stored in the buffer at the (i−1)^{th} time into a group of fused point cloud data further comprises:
when the difference is not less than the preset difference, determining the group of fused point cloud data based on a light spot area of the point cloud data obtained at the i^{th} time and a light spot area of the point cloud data stored in the buffer at the (i−1)^{th} time.

11. The method according to claim 10, wherein the determining the group of fused point cloud data based on a light spot area of the point cloud data obtained at the i^{th} time and a light spot area of the point cloud data stored in the buffer at the (i−1)^{th} time comprises:
when the light spot area of the point cloud data obtained at the i^{th} time is not less than the light spot area of the point cloud data stored in the buffer at the (i−1)^{th} time, performing at least one of the following:
when a value of the light spot area or a distance of the group of point cloud data stored in the buffer at the (i−1)^{th} time is 0, determining the point cloud data obtained at the i^{th} time as the group of fused point cloud data;
when the light spot area of the group of point cloud data obtained at the i^{th} time is greater than a saturation area, the light spot area of the group of point cloud data stored in the buffer at the (i−1)^{th} time is greater than a preset area, a difference between the light spot area of the group of point cloud data obtained at the i^{th} time and the light spot area of the group of point cloud data stored in the buffer at the (i−1)^{th} time is less than a preset area comparison threshold, and a value of the distance of the group of point cloud data stored in the buffer at the (i−1)^{th} time is not 0, determining the group of point cloud data stored in the buffer at the (i−1)^{th} time as the group of fused point cloud data; and
when the light spot area of the group of point cloud data obtained at the i^{th} time is not greater than the saturation area, the light spot area of the group of point cloud data stored in the buffer at the (i−1)^{th} time is not greater than the preset area, the difference between the light spot area of the group of point cloud data obtained at the i^{th} time and the light spot area of the group of point cloud data stored in the buffer at the (i−1)^{th} time is not less than a preset area comparison threshold, the difference between the distance of the group of point cloud data obtained at the i^{th} time and the distance of the group of point cloud data stored in the buffer at the (i−1)^{th} time is less than a preset distance comparison threshold, or the value of the distance of the group of point cloud data stored in the buffer at the (i−1)^{th} time is 0 and the light spot area is not 0, determining the group of point cloud data obtained at the i^{th} time as the group of fused point cloud data.

12. The method according to claim 10, wherein the determining the group of fused point cloud data based on a light spot area of the point cloud data obtained at the i^{th} time and a light spot area of the point cloud data stored in the buffer at the (i−1)^{th} time comprises:
when the light spot area of the point cloud data obtained at the i^{th} time is less than the light spot area of the point cloud data stored in the buffer at the (i−1)^{th} time, performing at least one of the following:
when the light spot area of the group of point cloud data stored in the buffer at the (i−1)^{th} time is greater than a saturation area and the value of the distance of the group of point cloud data obtained at the i^{th} time is not 0, determining the group of point cloud data obtained at the i^{th} time as the group of fused point cloud data; and
when the light spot area of the group of point cloud data stored in the buffer at the (i−1)^{th} time is not greater than the saturation area or the value of the distance of the group of point cloud data obtained at the i^{th} time is 0, determining the group of point cloud data stored in the buffer at the (i−1)^{th} time as the group of fused point cloud data.

13. The method according to claim 9, wherein the group of point cloud data obtained at the i^{th} time comprises a light spot area, and the light spot area is determined based on optical energy sampled by the first receiving unit for the i^{th} laser beam in the preset time interval, and
prior to obtaining the difference between the group of point cloud data obtained at the i^{th} time and the group of point cloud data stored in the buffer at the (i−1)^{th} time, further comprises:
determining that the light spot area of the group of point cloud data obtained at the i^{th} time is not less than the preset area.

14. The method according to claim 13, wherein the storing the group of point cloud data of the first receiving unit corresponding to respective laser beams in the preset time interval into the buffer in sequence further comprises:
when determining that the light spot area of the group of point cloud data obtained at the i^{th} time is less than the preset area, determining whether the light spot area of the group of point cloud data stored in the buffer at the (i−1)^{th} time is less than the preset area, and
when the light spot area of the group of point cloud data stored in the buffer at the (i−1)^{th} time is less than the preset area, storing the group of point cloud data obtained at the i^{th} time into the buffer at the i^{th} time, or
when the light spot area of the group of point cloud data stored in the buffer at the (i−1)^{th} time is not less than the preset area, storing the group of point cloud data stored in the buffer at the (i−1)^{th} time into the buffer at the i^{th} time.

15. A sampling data processing apparatus, comprising:
an emitting module, configured to emit laser beams for multiple times;
a sampling module, comprising at least two receiving blocks, wherein the at least two receiving blocks are configured to sample echoes of a laser beam emitted for one time, to obtain sampling data of the at least two receiving blocks for the laser beam emitted for one time respectively, wherein a first receiving block in the at least two receiving blocks is used to sample a laser beam emitted for an Nth time and a laser beam emitted for an (N+1)th time, and a second receiving block in the at least two receiving blocks is used to sample a laser beam emitted for the Nth time but is not used to sample a laser beam emitted for the (N+1)th time, and N is an integer greater than or equal to 1;
an obtaining module, configured to obtain a point cloud data of the laser beam emitted for one time corresponding to the at least two receiving blocks respectively based on the sampling data of the at least two receiving blocks for the laser beam emitted for one time respectively; and
a generating module, configured to generate a frame of point cloud data based on the point cloud data of the laser beam emitted for one time corresponding to at least one of the receiving blocks.
